(19) United States
(12) Patent Application Publication
(10) Pub. No.: US 2013/0197800 A1
(43) Pub. Date: Aug. 1, 2013

(54) METHOD AND SYSTEM FOR GPS AUGMENTATION USING COOPERATIVE ALTITUDE LEARNING

(71) Applicant: ONN HARAN, Bnei Dror (IL)

(72) Inventor: ONN HARAN, Bnei Dror (IL)

(73) Assignee: AUTOTALKS LTD., KFAR NETTER (IL)

(21) Appl. No.: 13/709,261

(22) Filed: Dec. 10, 2012

Related U.S. Application Data
(60) Provisional application No. 61/592,682, filed on Jan. 31, 2012.

(51) Int. Cl. G01S 19/40

(52) U.S. Cl. CPC G01S 19/40
USPC 701/445

(57) ABSTRACT

A method for GPS augmentation in a local vehicle located in a particular road section comprises cooperatively learning an averaged external altitude for the particular road section, obtaining an internal altitude for the particular road section, and using the averaged external altitude and the internal altitude to obtain an augmented local altitude for the particular road section. The augmented local altitude is then used to provide an augmented position for the particular road section. The averaged external altitude is learned cooperatively, using external altitudes obtained for the particular road section and transmitted by other vehicles which previously passed through that section. Only reliable external altitude values, as determined from respective VDOP parameters, are used in the cooperative altitude learning.

### CROSS REFERENCE TO RELATED APPLICATIONS

This application is related to and claims priority from U.S. Provisional Patent Application No. 61/592,682 filed Jan. 31, 2012, which is incorporated herein by reference in its entirety.

### FIELD

Method and system embodiments disclosed herein relate generally to GPS augmentation and more specifically to improvement of the GPS positioning accuracy of a particular vehicle by using a cooperatively learned averaged external altitude input together with an internal altitude input in the positioning equation which specifies the position of the particular vehicle.

### BACKGROUND

In known art as applied to vehicles as well as other entities, a GPS receiver obtains (reads) positioning data periodically (e.g. every 0.1 sec) and solves positioning equations (which include altitude and horizontal X-Y coordinates) according to its best ability and knowledge of received signals. Each vehicular GPS receiver also performs an estimated quality of altitude calculation reflected by a Vertical Dilution of Precision (VDOP) parameter. The VDOP is calculated per GPS reading and is transmitted in each message between vehicles together with GPS positioning information. It is well known that the GPS accuracy is limited, i.e. that a GPS positioning error (or simply “GPS error”) is significant The GPS error is due to several error factors which have been thoroughly investigated in the literature. For example, under harsh GPS reception conditions such as those occurring in an “urban canyon” (i.e. a city with skyscrapers) and more generally in locations where there are obstructions to line-of-sight GPS signals, a GPS based altitude calculation suffers from an error which may easily exceed 100 m. This error translates into a horizontal (X-Y) positioning error of several tens of meters, because the intersecting X-Y point of all received satellites is different from a real value when the assumed altitude is wrong.

The GPS accuracy may be improved (augmented”) by, for example, sharing the raw data of a number of satellites. One major drawback of raw data sharing methods is their ineffectiveness in an urban canyon, because of the high variation in raw data received by different vehicles. While under an open sky the GPS error can be decreased significantly, the ability to reduce errors in an urban canyon with severe multipath is limited, because reflections in an urban environment may be stronger than a direct GPS signal. Another major drawback is the need to transmit extensive amounts of data, thereby loading the wireless link. In addition, the complexity of raw data processing is very high, and actual implementations show that the performance is limited and that the processing of data of more than a very few vehicles is impractical.

There is therefore a need for, and it would be advantageous to have, methods and systems for increasing the GPS accuracy, particularly for vehicles travelling in an urban environment where GPS signals are obscured, such as an urban canyon.

### SUMMARY

Method and system embodiments disclosed herein teach GPS augmentation in a vehicular environment using cooperative altitude learning. As used herein, “cooperative altitude learning” refers to the process of obtaining and using selected external altitude inputs related to a particular location on a road (also referred to as “road section” or “tile”) to augment the altitude of the particular tile, and using the augmented altitude in GPS positioning equations. The cooperative altitude learning process is based on exchanging GPS location information between neighboring vehicles through wireless vehicle-to-vehicle communication. Altitude information is constantly sent in messages transmitted periodically by all vehicles as part of the existing message specification. The process does not require modification of existing standards and does not overload the network.

As used herein, “road” may refer to any path on which a vehicle may travel. A “vehicle” may include any means of transportation. When a particular vehicle is located in a particular tile, the particular vehicle is referred to as being “local” in the particular tile. Exemplarily, when a vehicle A is located in a tile B, vehicle A is local in tile B. Tile B is then a “local tile” (with respect to vehicle A). Following this example, an “external” altitude input is an altitude input for tile B received by local vehicle A from another, “neighboring” vehicle C which is within communication range, and which was positioned previously in tile B. Vehicle C obtained the “external” altitude input transmitted to other vehicles (including vehicle A) when it was local in tile B. An “internal” altitude input is an input obtained by a local vehicle from its own (“internal” or “local”) GPS receiver. In the example above, this is done in vehicle A while local in tile B. External altitude inputs obtained from various neighboring vehicles are averaged to a single “averaged external altitude”. This averaged external altitude is combined with the internal altitude in a system in the local vehicle to obtain an augmented altitude. The augmented altitude is then used to calculate the X-Y position of the local tile.

Only “reliable” (to be defined below) external altitude inputs are used to calculate the averaged external altitude. A database (see 206 in FIG. 2) provided in a system located in each vehicle stores the external altitude values together with VDOP, X-Y and layer altitude values (the latter explained below) as entries related to a particular tile. This is done for all tiles in a tile map which is also stored in the database. The entries are updated constantly, as new external altitude inputs are received from vehicles passing through the particular tile and as a new averaged external altitude is calculated for each tile stored in the database. When a particular vehicle reaches a particular tile, it uses its internal altitude input and the latest (most updated) external altitude from the database to calculate the most accurate (i.e. augmented) altitude for the particular tile. As mentioned, this augmented altitude value is then fed to the positioning equation and used to improve the accuracy of the calculation of horizontal positioning GPS axes in the particular tile.

To simplify the description, the word “value” may be henceforth dropped from mentioned parameters (such as altitude and VDOP).

The GPS augmentation disclosed herein provides a very significant advantage, particularly in an urban environment in which very few satellites are received with line-of-sight. By removing the need to calculate altitude in the positioning equation (because an accurate altitude is available for each tile), only three good satellite signals are needed instead of the four satellites needed when altitude has also to be calculated.

In some embodiments, there is provided a method for GPS augmentation comprising the steps of: in a particular vehicle currently located in a particular road section, obtaining an averaged external altitude for the particular road section, obtaining a local (internal) altitude and using the averaged external and local altitudes to obtain an augmented local altitude for the particular road section. The augmented local altitude is then used to provide an augmented position for the particular road section. The step of cooperatively learning an averaged external altitude includes obtaining a plurality of external altitude inputs for the particular road section and averaging at least some of the external altitude inputs to obtain the averaged external altitude. Preferably, the averaging of at least some of the external altitude inputs includes using only reliable external inputs as indicated by a respective VDOP associated with each external altitude input. In some embodiments, the method further comprises averaging the respective VDOPs of the reliable external inputs to obtain an averaged external VDOP. The averaged external altitude and averaged external VDOP are stored in an internal database and updated periodically to provide updated external altitudes and VDOPs.

In some embodiments, there is provided a method for GPS augmentation comprising the steps of: in a vehicle, building an internal map which divides a road travelled by the vehicle into sections, each road section having a respective position, averaged external altitude and averaged external VDOP associated therewith and stored in an internal database in the vehicle; obtaining an internal altitude for a particular road section in which the vehicle is local; weighting the internal altitude with an averaged external altitude for the particular road section to obtain an augmented altitude for the particular road section; and using the augmented altitude to provide an augmented position for the particular road section.

In some method embodiments, the averaged external altitude and averaged external VDOP for the particular road section are calculated by averaging external altitude and VDOP inputs provided by neighboring vehicles.

In some method embodiments, the external altitude inputs include only reliable external altitude inputs.

In some method embodiments, an external altitude input is considered reliable if a respective VDOP associated therewith is smaller than a threshold.

In some method embodiments, the respective external altitude and VDOP inputs are obtained and transmitted by the neighboring vehicle while the neighboring vehicle is local in the particular road section.

In some embodiments, there is provided a system for GPS augmentation installed in a vehicle and comprising: a vehicle-to-vehicle communication unit which exchanges periodically GPS information with other vehicles; a modified GPS receiver which provides internal position, altitude and VDOP inputs associated with a particular road section in which the vehicle is local and which calculates an augmented position for the particular road section; a cooperative altitude learning module for weighting the internal altitude input with an averaged external altitude learned by the vehicle, to obtain an augmented altitude for the particular road section, the augmented altitude fed to the modified GPS receiver to calculate the augmented position for the particular road section; and a database for storing and periodically updating an internal map of road section and altitude, position and VDOP values associated with each road section.

In some system embodiments, the modified GPS receiver is adapted to receive an augmented altitude and to recalculate at least once an augmented position for the particular road section based on the received augmented altitude.

In some system embodiments, the cooperative altitude learning module is adapted to average a plurality of external altitude inputs to obtain the averaged external altitude.

In some system embodiments, the external altitude inputs are reliable inputs as determined from a comparison of a VDOP associated with each external altitude with a threshold. An external altitude input is considered reliable if the VDOP associated therewith is smaller than the threshold.

### BRIEF DESCRIPTION OF THE DRAWINGS

Non-limiting embodiments of the invention are herein described, by way of example only, with reference to the accompanying drawings, wherein:

FIG. 1 illustrates schematically an exemplary situation and scenario for implementing a method disclosed herein;

FIG. 2 shows schematically in a block diagram an embodiment of a system for implementing methods disclosed herein;

FIG. 3 describes an exemplary cooperative altitude learning process;

FIG. 4 illustrates the process of augmenting a local (particular) GPS receiver result utilizing a learned average external altitude according to a method embodiment disclosed herein.

### DETAILED DESCRIPTION

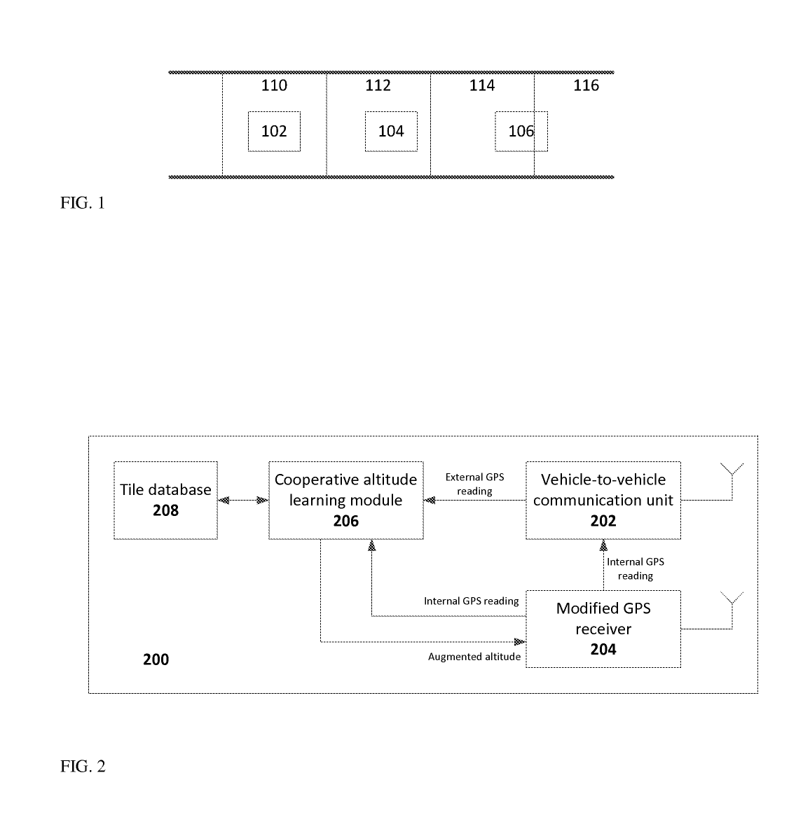

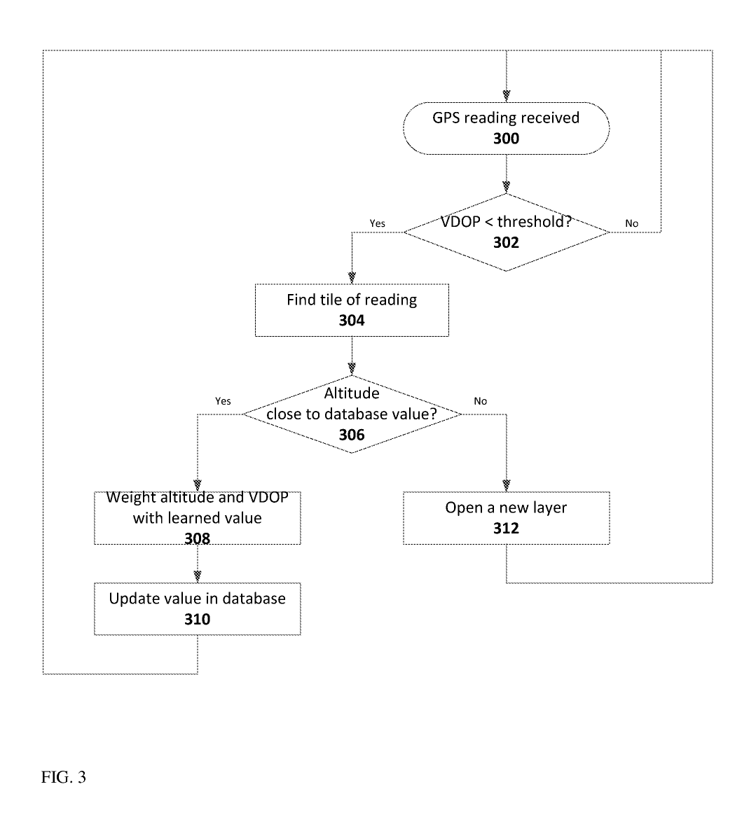

FIG. 1 illustrates schematically an exemplary situation and scenario for implementing a method disclosed herein. Four vehicles marked 102, 104 and 106 are shown as driving on a road 108 in the right direction. In general, there may be more vehicles within a vehicular communication range (typically around 300 m). The road is divided into tiles of arbitrary size, for example 4×4 m. Four such tiles are marked in FIGS. 1 as 110, 112, 114 and 116. In this example, each tile has a square shape. In other embodiments, the road may be divided into differently shaped tiles, for example rectangular tiles. As shown, the current (momentary) position of the three vehicles is as follows: vehicle 102 is positioned (“local”) in tile 110, vehicle 104 is local in tile 112 and vehicle 106 straddles the boundary between tiles 114 and 116. Each vehicle reports periodically (e.g. every 0.1 seconds) its altitude, as provided by its respective GPS receiver or as a calculated augmented altitude. This information is received by all vehicles within communication range. The altitude of a single tile is considered constant. If the road includes features with different altitudes, such as bridges or tunnels, then “layers” of different altitude are allocated to each feature for purposes set forth herein. Each layer has a distinct altitude. In general, each vehicle learns the altitude reported previously by the other vehicles for each tile passed through and builds an internal map (internal to the vehicle) with the reported altitude values (including its internal altitude input for the tile it is local in). The altitude cooperatively learned by a vehicle for a particular tile is an “averaged external altitude” for that tile and is updated constantly, as new altitude inputs are obtained for the particular tile. Exemplarily, vehicle 102 learns the altitude reported previously by the other vehicles (e.g. 104 and 106, as well as other vehicles not shown but within communication range of vehicle 102) for each tile passed through by these vehicles and builds its internal map, which is stored in an internal database, The map includes updated averaged altitudes per tile. An exemplary learning procedure is described in detail with reference to FIG. 3. The averaged external altitude for tile 114 includes the altitude for tile 114 reported by vehicle 106 and by all other vehicles that passed through that tile. The averaged altitude for tile 112 includes the altitude for tile 112 reported by vehicles 104 and 106 along with that reported by the other vehicles which passed through tile 112. The averaged altitude for tile 110 includes the altitude for tile 110 reported by vehicles 102, 104 and 106 along with that reported by the other vehicles which passed through tile 110. As mentioned, the averaged altitude for a particular tile is updated constantly if new external altitude inputs are received for that tile.

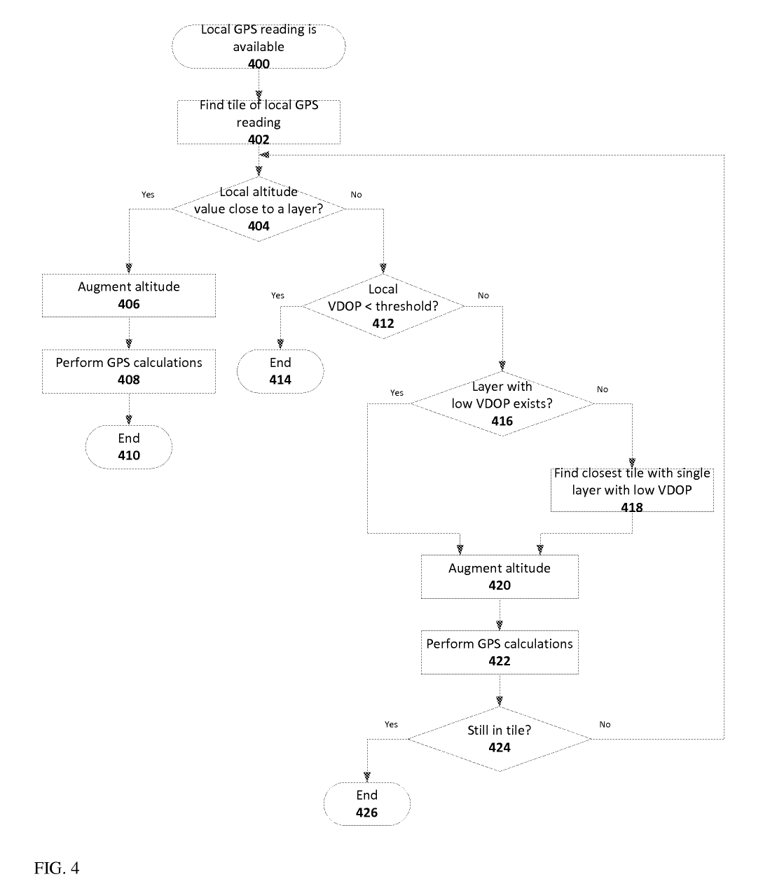

Note that the process of learning an averaged altitude for each tile is done continuously, so that each tile has an updated external altitude associated therewith. When a particular vehicle reaches a particular tile (e.g. when vehicle 102 reaches tile 112), its own internal altitude reading is weighted with the latest (most recently updated) averaged external altitude of the particular tile to provide the augmented altitude for the particular tile. The augmented altitude is then fed back to the GPS receiver in the particular vehicle, which recalculates its current position. Given that as mentioned a vehicular communication range is about 300 meters (and in some cases somewhat more), the number of vehicles which have passed through a particular tile before the particular vehicle reaches it may be quite large. In this case, a good external altitude can be obtained for the particular tile before the vehicle augments its altitude. An exemplary method of utilizing the learned (external) averaged altitude for local altitude augmentation is described in detail with reference to FIG. 4.

An embodiment of a system for implementing methods disclosed herein and marked 200 is shown schematically in a block diagram in FIG. 2. System 200 includes a vehicle-to-vehicle communication unit 202 which exchanges communication packets with other vehicles; a modified GPS receiver 204 which provides a current vehicle position and altitude and VDOP to be communicated by unit 202 to other vehicles within range; a cooperative altitude learning module 206, implemented typically in software (SW) code on a central processing unit (CPU); and a tile database 208 which stores and updates periodically altitude, position and VDOP values for each tile. The CPU (not shown) may be the same CPU as that of the GPS receiver. The CPU averages external altitude inputs received from other vehicles to obtain an averaged external altitude to be stored in the database. GPS receiver 204 provides a current position to altitude learning module 206, which in turn provides the respective external altitude related to the current position back to the GPS receiver. The GPS receiver is “modified” vs. known receivers in that it is adapted to receive the augmented altitude and to perform multiple times the positioning calculation.

The cooperative altitude learning process feeds the GPS receiver with an augmented altitude. The “control” shown indicates a command to recalculate the current GPS position based on the augmented altitude. The scheme helps to reduce the relative positioning error between any two vehicles participating in vehicle-to-vehicle communication, because the common altitude variable (i.e. the reduced difference between their altitude values) increases the similarity between the GPS position calculations at the two different receivers, and therefore reduces the differential error. Safety applications based on vehicle-to-vehicle communication have high importance for relative positioning for analyzing potential road risks, even higher than absolute GPS error accuracy.

FIG. 3 describes an exemplary cooperative altitude learning process, performed in a vehicle which carries a system 200. This process builds database 208. As indicated, stored values include a reliable averaged altitude and a reliable averaged VDOP for each tile. These values are updated periodically. The database is filled initially with average altitude and VDOP values based on the first reports from vehicles in range, after which the “learning” for a particular tile is essentially an updating process. The process begins with step 300, each time a message containing “external” GPS information (external altitude, position and external VDOP) is received from a neighboring vehicle. The reliability of the information, based on the received (external) VDOP is checked in step 302, where the VDOP is compared with a threshold. The threshold is selected to ensure a reasonable quality of the information. Exemplarily, a threshold below 5 is considered adequate, with the quality increasing with decreasing threshold value. If the VDOP is larger than the chosen threshold (NO in step 302), the GPS information received from the neighboring vehicle is considered unreliable and is not used. In this case, operation returns to step 300. If the received VDOP is smaller than the chosen threshold (YES in step 302) then the information received from the neighboring vehicle is considered reliable and operation continues to step 304, which identifies the particular tile. At this point, the particular “neighboring” tile from which the neighboring vehicle reported in step 300 is identified. In step 306, the external altitude is compared with learned altitudes of different layers for the particular tile. If the external altitude is close enough to one of the known layer altitudes, for example closer than 2 meters, step 308 is performed. The received external altitude and external VDOP are weighted with current (most recent) averaged external altitude and VDOP values for the particular tile, to obtain updated altitude and VDOP values. The weighting may be done for example as follows:

Updated altitude=(Current averaged external altitude*External VDOP+External altitude*Current averaged external VDOP)/(Current averaged external VDOP+External VDOP) (1)

and

Updated VDOP=(external VDOP*Current averaged external VDOP)/(external VDOP+Current averaged external VDOP) (2)

Note that other weighing schemes may be used, and the one expressed by equations 1 and 2 should not be seen as limiting. The updated values are stored in the database in step 310, and operation returns to step 300.

Returning now to FIG. 3, if in step 306 the received external altitude is not close enough to the altitude of one of the known layers, for example not closer than 2 meters, then this received external altitude needs to be associated with a different layer. Step 312 then opens a new layer, storing the external altitude and layer associated therewith in database 208. The process restarts at step 300 with a new message containing “external” GPS information. Advantageously, this process leads to simplified altitude learning per tile and to consideration of only reliable altitude values by moving the low-reliability values to different layers or by discarding them.

FIG. 4 describes the process of augmenting an internal GPS receiver result utilizing a respective averaged external altitude. This process occurs when a vehicle becomes local in a particular “local” tile. Its GPS receiver provides current internal altitude and VDOP inputs.

These internal inputs are then averaged with the latest (updated) altitude and VDOP values calculated in (1) and (2) for the local tile to obtain augmented altitude and VDOP values for this tile. The augmented altitude value is then used to improve the accuracy of the local GPS positioning Operation begins in step 400, after the internal GPS receiver provides new internal altitude and VDOP inputs. The local tile is identified in step 402. The new internal altitude is compared with the learned altitude of the various layers of the local tile in step 404. If the new internal altitude is close enough to one of the learned layer altitudes, for example less than 2 meters, then operation jumps to step 406, where the altitude and VDOP values for the local tile are augmented, using an equation similar to that used for averaging in step 308:

Augmented local altitude=(Averaged external altitude*Internal VDOP+Internal altitude.*Averaged external VDOP)/(internal VDOP+Averaged external VDOP) (3)

and

Augmented local VDOP=(local VDOP*Averaged external VDOP*2)/(local VDOP+2*Averaged external VDOP) (4)

Note that the averaged external altitude and VDOP values represent a specific layer. Also note that other weighing schemes may be used, and the one expressed by equations 3 and 4 should not be seen as limiting. The augmented local altitude is re-applied in the GPS positioning equations, and a more accurate GPS position is recalculated in step 408. To summarize the augmentation GPS process in a particular vehicle currently located in a particular tile, a reliable external averaged altitude is weighted with an internal (local) altitude to provide an augmented local altitude, and the internal position is fixed based on the augmented local altitude. Operation is completed in step 410.

If in step 404 the local altitude is not close enough to one of the learned layer altitudes, for example not less than 2 meters, then the operation moves to a check in step 412, in which the local VDOP is compared with a threshold. If the local VDOP is below threshold, then the altitude is accurate enough, and no augmentation is performed. Operation is completed in step 414. If in step 412 the altitude is found not to be accurate enough, a check is made in step 416 if a single layer with a good quality external average VDOP is defined for the tile. If the average VDOP is higher than a defined threshold, a search for a closest neighbor tile with a single layer with a good quality VDOP lower than the threshold is performed in step 418. If such a layer is found, the altitude and VDOP values of this layer are taken for the tile and operation continues from step 420. If the check in step was 416 was positive, then no adjustment is needed and operation skips directly to step 420. In step 420, the same operation described for step 406 is performed but with lower weights applied for the layers. Step 422, identical to step 408, is then performed.

A check is made in step 424 if the particular vehicle is still “local” in the particular tile. The GPS error resulting from a wrong altitude calculation can be very high. Advantageously, this iterative process repeats the calculation until a valid altitude value is used in the calculation. If Yes in step 424 (the tile found is not changed), then the operation ends in step 426. If No in step 424, operation is repeated from step 404. Most likely, only a single iteration is required for performing the entire augmentation scheme, until the augmented position is stable in the particular tile.

While this disclosure has been described in terms of certain embodiments and generally associated methods, alterations and permutations of the embodiments and methods will be apparent to those skilled in the art. The disclosure is to be understood as not limited by the specific embodiments described herein, but only by the scope of the appended claims.

1. A method for GPS augmentation comprising the steps of: in a particular vehicle currently located in a particular road section:
a) cooperatively learning an averaged external altitude for the particular road section;
b) obtaining a current internal altitude; and
c) using the cooperatively learned averaged external altitude and the current internal altitude to obtain an augmented altitude for the particular road section.

2. The method of claim 1, further comprising the step of:
d) using the augmented altitude to provide an augmented position for the particular road section.

3. The method of claim 2, wherein the step of cooperatively learning an averaged external altitude includes obtaining a plurality of external altitude inputs for the particular road section and averaging at least some of the external altitude inputs to obtain the averaged external altitude.

4. The method of claim 3, wherein the averaging at least some of the external altitude inputs includes using only reliable external inputs as indicated by a respective vertical dilution of precision (VDOP), the method further comprising averaging the respective VDOPs of the reliable external inputs to obtained an averaged external VDOP.

5. The method of claim 3, wherein the averaging at least some of the external altitude inputs is followed by storing the averaged external altitude and averaged external VDOP in an internal database.

6. The method of claim 5, wherein the stored averaged external altitude and averaged external VDOP are updated periodically to provide updated external altitude and VDOP values.

7. The method of claim 4, wherein the using only reliable external inputs as indicated by a respective VDOP includes determining if an external altitude input is reliable by comparing its respective VDOP to a threshold.

8. A method for GPS augmentation comprising the steps of: in a vehicle:
a) building an internal map which divides a road travelled by the vehicle into sections, each road section having respective position, averaged external altitude and averaged external vertical dilution of precision (VDOP) values associated therewith and stored in an internal database in the vehicle;
b) obtaining an internal altitude for a particular road section in which the vehicle is local;
c) weighting the internal altitude with an averaged external altitude for the particular road section to obtain an augmented altitude for the particular road section; and
d) using the augmented altitude to provide an augmented position for the particular road section.

9. The method of claim 8, wherein the averaged external altitude and averaged external VDOP for the particular road section are calculated by averaging external altitude and VDOP inputs provided by neighboring vehicles.

10. The method of claim 9, wherein the external altitude inputs include only reliable external altitude inputs.

11. The method of claim 10, wherein an external altitude input is considered reliable if a respective VDOP associated therewith is smaller than a threshold.

12. The method of claim 9, wherein an external altitude and VDOP input provided by a neighboring vehicle is obtained and transmitted by the neighboring vehicle while the neighboring vehicle is local in the particular road section.

13. The method of claim 8, wherein the step of building an internal map includes allocating a plurality of layers of different altitude for a particular feature on the road, and associating the particular road section with a particular layer altitude.

14. A system for GPS augmentation installed in a vehicle and comprising:
a) a vehicle-to-vehicle communication unit which exchanges periodically GPS information with other vehicles;
b) a modified GPS receiver which provides internal position, altitude and vertical dilution of precision (VDOP) inputs associated with a particular road section in which the vehicle is local and which calculates an augmented position for the particular road section;
c) a cooperative altitude learning module for weighting the internal altitude input with an averaged external altitude learned by the vehicle, to obtain an augmented altitude for the particular road section, the augmented altitude fed to the modified GPS receiver to calculate the augmented position for the particular road section; and
d) a database for storing and periodically updating an internal map of road section and altitude, position and VDOP values associated with each road section.

15. The system of claim 14, wherein the modified GPS receiver is adapted to receive an augmented altitude and to recalculate at least once an augmented position for the particular road section based on the received augmented altitude.

16. The system of claim 14, wherein the cooperative altitude learning module is adapted to average a plurality of external altitude inputs to obtain the averaged external altitude.

17. The system of claim 16, wherein the external altitude inputs are reliable inputs as determined from a comparison of VDOP values associated therewith with a threshold.

18. The system of claim 17, wherein an external altitude input is considered reliable if the VDOP associated therewith is smaller than the threshold.
